(19) United States
(12) Patent Application Publication
(10) Pub. No.: US 2024/0053151 A1
(43) Pub. Date: Feb. 15, 2024

(54) METHOD OF DETERMINING ROUTE OF AUTOMATED GUIDED VEHICLE AND ROUTE DETERMINING SYSTEM OF AUTOMATED GUIDED VEHICLE FOR PERFORMING THE SAME

(71) Applicant: Samsung Display Co., LTD., Yongin-si (KR)

(72) Inventor: YONGGU KIM, Yongin-si (KR)

(21) Appl. No.: 18/218,040

(22) Filed: Jul. 4, 2023

(30) Foreign Application Priority Data
Aug. 11, 2022 (KR) 10-2022-0100840

(51) Int. Cl. G01C 21/20; G07C 5/00; G07C 5/08

(52) U.S. Cl. CPC G01C 21/206; G07C 5/008; G07C 5/0808; G05D 1/0212

(57) ABSTRACT

A method of determining a route of a main automated guided vehicle includes: determining whether a work is assigned to the main automated guided vehicle; extracting a first and second control points of the work when the work is assigned to the main automated guided vehicle; determining whether multiple routes exist from the first control point to the second control point; determining a single route as a final route of the main automated guided vehicle when the number of routes from the first control point to the second control point is one; predicting a moving time of the main automated guided vehicle for all candidate routes and determining a shortest time route among the candidate routes as the final route of the main automated guided vehicle, when the number of the routes from the first control point to the second control point is equal to or greater than two.

This application claims priority to Korean Patent Application No. 10-2022-0100840, filed on Aug. 11, 2022, and all the benefits accruing therefrom under 35 U. S. C. § 119, the content of which in its entirety is herein incorporated by reference.

### BACKGROUND

### 1. Field

Embodiments of the present invention relate to a method of determining a route of an automated guided vehicle and a route determining system of an automated guided vehicle for performing the method. More particularly, embodiments of the present invention relate to a method of determining a route of an automated guided vehicle in which the shortest time route is determined as the route of the automated guided vehicle through a real-time simulation and a route determining system of an automated guided vehicle for performing the method.

### 2. Description of the Related Art

An automated guided vehicle is one of automation equipment used in a production plant, etc., and performs work while moving along locations where the equipment is located in the production plant, that is, along predetermined layouts.

The automated guided vehicle may include a vehicle body and a driving device for driving the vehicle body. The driving device may include a plurality of driving wheels installed in a lower region of the vehicle body to drive the vehicle body. A wheel driving motor receiving driving force from a battery and driving each driving wheel may be disposed at a side of each driving wheel. An obstacle sensor for detecting an obstacle may be disposed in a front region the vehicle body.

In addition, the automated guided vehicle may include an unmanned communication unit for communication with an external central controller and an inner controller controlling driving of each wheel driving motor based on signals detected from the obstacle sensor according to a command received by the unmanned communication unit from the central controller.

The central controller may determine a status of an entire system and transmit work commands to be performed by each of the automated guided vehicles in a predetermined communication format to each of the automated guided vehicles. The automated guided vehicle may receive the work commands transmitted from the central controller and move along an indicated route according to the instructed work commands or perform an indicated transport work.

When several automated guided vehicles are operated in the same workspace, it frequently occurs that the automated guided vehicles approach within a certain distance or driving routes of the automated guided vehicles overlap. Accordingly, it may be necessary to control driving such that the automated guided vehicles do not collide while driving. In addition, when there are plural possible routes for the automated guided vehicle, it may be necessary to determine an appropriate route.

### SUMMARY

Embodiments of the present invention provide a method of determining a route of an automated guided vehicle in which the shortest time route is determined as the route of the automated guided vehicle through a real-time simulation.

Embodiments of the present invention also provide a route determining system of an automated guided vehicle for performing the method.

In an embodiment of a method of determining a route of a main automated guided vehicle of the present invention, the method includes: determining whether a work is assigned to the main automated guided vehicle; extracting a first control point and a second control point of the work when the work is assigned to the main automated guided vehicle; determining whether multiple routes exist from the first control point to the second control point; determining a single route as a final route of the main automated guided vehicle when the number of routes from the first control point to the second control point is one; predicting a moving time of the main automated guided vehicle for all candidate routes and determining a shortest time route among the candidate routes as the final route of the main automated guided vehicle, when the number of the routes from the first control point to the second control point is equal to or greater than two.

In an embodiment, the predicting of the moving time of the main automated guided vehicle may include determining current positions of automated guided vehicles in an unmanned transport system including the main automated guided vehicle and simulation times for the automated guided vehicles in the unmanned transport system.

In an embodiment, the predicting of the moving time of the main automated guided vehicle may include checking automated guided vehicles positioned ahead on the route for each of automated guided vehicles in an unmanned transport system.

In an embodiment, the predicting of the moving time of the main automated guided vehicle may include checking a crossing automated guided vehicle crossing a same intersection with the main automated guided vehicle.

In an embodiment, a vehicle having a long simulation time of the main automated guided vehicle and the crossing automated guided vehicle may obtain a priority.

In an embodiment, the first control point may be a control point right after a starting point. The second control point may be a control point right before a destination.

In an embodiment, the first control point may be a control point right after a starting point. The second control point may be a control point of a destination.

In an embodiment, the predicting of the moving time of the main automated guided vehicle may include initializing simulation times of all of automated guided vehicles in an unmanned transport system including the main automated guided vehicle and a current time (operation S1), determining current positions of all of the automated guided vehicles (operation S2) and determining the simulation times of all of the automated guided vehicles (operation S3).

In an embodiment, the predicting of the moving time of the main automated guided vehicle may further include determining whether the main automated guided vehicle arrives at the second control point (operation S4) and returning the current time as a final arrival time when the main automated guided vehicle arrives at the second control point (operation S5).

In an embodiment, the predicting of the moving time of the main automated guided vehicle may further include determining whether the main automated guided vehicle arrives at the second control point (operation S4), increasing the current time by one unit time and initializing a check count (CHKCNT) of all of the automated guided vehicles when the main automated guided vehicle does not arrive at the second control point CP2 (operation S6), initializing an error signal (CHKALL) of the candidate route and initializing status signals (CHKAGV) of all of the automated guided vehicles (operation S7), checking automated guided vehicles positioned ahead on the route for each of the automated guided vehicles in the unmanned transport system (operation S8) and initializing a sequence (i) of a tested automated guided vehicle among the automated guided vehicles in the unmanned transport system to 1 (operation S9).

In an embodiment, the predicting of the moving time of the main automated guided vehicle may further include determining whether the simulation time of an i-th automated guided vehicle is greater than the current time (operation S10) and determining the status signal (CHKAGV) of the i-th automated guided vehicle as a normal status when the simulation time of the i-th automated guided vehicle is less than or equal to the current time (operation S15) and increasing the sequence (i) of the tested automated guided vehicle by 1 (operation S20).

In an embodiment, the predicting of the moving time of the main automated guided vehicle may further include determining whether the sequence (i) is greater than or equal to the number of the automated guided vehicles in the unmanned transport system after increasing the sequence (i) by 1 (operation S21) and checking the error signal (CHKALL) of the candidate route when the sequence (i) is greater than or equal to the number of the automated guided vehicles in the unmanned transport system after increasing the sequence (i) by 1 (operation S22). When the error signal (CHKALL) of the candidate route has a normal status, the operation S2 in which the current positions of all of the automated guided vehicles are determined may be performed. When the sequence (i) is less than the number of the automated guided vehicles in the unmanned transport system, the operation S10 in which whether the simulation time of the i-th automated guided vehicle is greater than the current time is determined may be performed.

In an embodiment, the predicting of the moving time of the main automated guided vehicle may further include determining whether the automated guided vehicle positioned ahead does not exist on the routes for the i-th automated guided vehicle (operation S11) when the simulation time of an i-th automated guided vehicle is greater than the current time in the operation S10, determining whether the automated guided vehicle positioned ahead of the i-th automated guided vehicle is in an abnormal situation (operation S16) when the automated guided vehicle positioned ahead is on the route for the i-th automated guided vehicle, updating the error signal (CHKALL) of the candidate route to the error status and increasing the check count (CHKCNT) of the i-th automated guided vehicle by 1 (operation S18) when the automated guided vehicle positioned ahead is in the abnormal situation, determining whether the check count (CHKCNT) of the i-th automated guided vehicle is less than a threshold (operation S19) and returning the final arrival time of the candidate route as a maximum value (operation S23) when the check count (CHKCNT) of the i-th automated guided vehicle is greater than or equal to the threshold. When the check count (CHKCNT) of the i-th automated guided vehicle is less than the threshold, the operation S20 of increasing the sequence (i) by 1 may be performed.

In an embodiment, the predicting of the moving time of the main automated guided vehicle may further include determining whether a crossing automated guided vehicle crossing a same intersection with the i-th automated guided vehicle exists (operation S12) when the automated guided vehicle positioned ahead is not in the abnormal situation in the operation S16 and comparing the simulation time of the i-th automated guided vehicle and a simulation time of the crossing automated guided vehicle (operation S17) when the crossing automated guided vehicle exists. When the simulation time of the i-th automated guided vehicle is greater than or equal to the simulation time of the crossing automated guided vehicle, the operation S15 in which the status signal (CHKAGV) of the i-th automated guided vehicle is determined as the normal status may be performed.

In an embodiment, the predicting of the moving time of the main automated guided vehicle may further include determining whether the i-th automated guided vehicle is movable to a next control point (operation S13) when the crossing automated guided vehicle does not exist in the operation S12 or when the simulation time of the i-th automated guided vehicle is less than the simulation time of the crossing automated guided vehicle in the operation S17 and moving the i-th automated guided vehicle to the next control point when the i-th automated guided vehicle is movable to the next control point, and adding a rotation time to the simulation time of the i-th automated guided vehicle when a rotation of the i-th automated guided vehicle is required (operation S14). When the i-th automated guided vehicle is not movable to the next control point, the operation S15 of determining the status signal (CHKAGV) of the i-th automated guided vehicle as the normal status may be performed.

In an embodiment, the work may include a first work in which the main automated guided vehicle moves to a starting point and a second work in which the main automated guided vehicle moves from the starting point to a destination.

In an embodiment of a route determining system of a main automated guided vehicle of the present invention, the route determining system includes a plurality of automated guided vehicles including the main automated guided vehicle and a controller. The controller is configured to communicate with the automated guided vehicles. The controller is configured to determine whether a work is assigned to the main automated guided vehicle, extract a first control point and a second control point of the work when the work is assigned to the main automated guided vehicle, determine whether multiple routes exist from the first control point to the second control point, determine a single route as a final route of the main automated guided vehicle when the number of routes from the first control point to the second control point is one, predict a moving time of the main automated guided vehicle for all candidate routes and determine a shortest time route among the candidate routes as the final route of the main automated guided vehicle, when the number of the routes from the first control point to the second control point is equal to or greater than two.

In an embodiment, the controller may be configured to determine current positions of the automated guided vehicles and simulation times for the automated guided vehicles.

In an embodiment, the controller may be configured to check automated guided vehicles positioned ahead on the route for each of the plurality of automated guided vehicles.

In an embodiment, the controller may be configured to check a crossing automated guided vehicle crossing a same intersection with the main automated guided vehicle.

According to the method of determining the route of the automated guided vehicle and the route determining system of the automated guided vehicle, the shortest route may be determined as the route of the automated guided vehicle through the real-time simulation of the moving time of the automated guided vehicles so that the moving time of the automated guided vehicle may be effectively reduced.

The influence of the movement of other automated guided vehicles is reflected to the moving route of the automated guided vehicle and traffic and congestion are reflected to the moving route of the automated guided vehicle so that the moving route of the automated guided vehicle may be optimized.

### BRIEF DESCRIPTION OF THE DRAWINGS

The above and other features and advantages of the invention will become more apparent by describing in detailed embodiments thereof with reference to the accompanying drawings, in which:

FIG. 1 is a route determining system of an automated guided vehicle according to an embodiment of the present invention;

FIG. 2 is a conceptual diagram illustrating the route determining system of the automated guided vehicle of FIG. 1;

FIG. 3 is a conceptual diagram illustrating movements of the automated guided vehicles over time in the route determining system of the automated guided vehicle of FIG. 1;

FIG. 4 is a flowchart diagram illustrating a method of determining the route of the automated guided vehicle performed by the route determining system of the automated guided vehicle of FIG. 1; and

FIGS. 5A and 5B are flowchart diagrams illustrating a step of predicting a moving time for each route in the method of determining the route of the automated guided vehicle of FIG. 4.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Hereinafter, the present invention will be explained in detail with reference to the accompanying drawings.

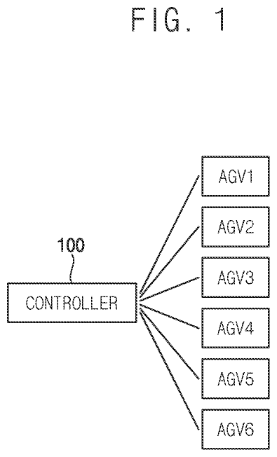

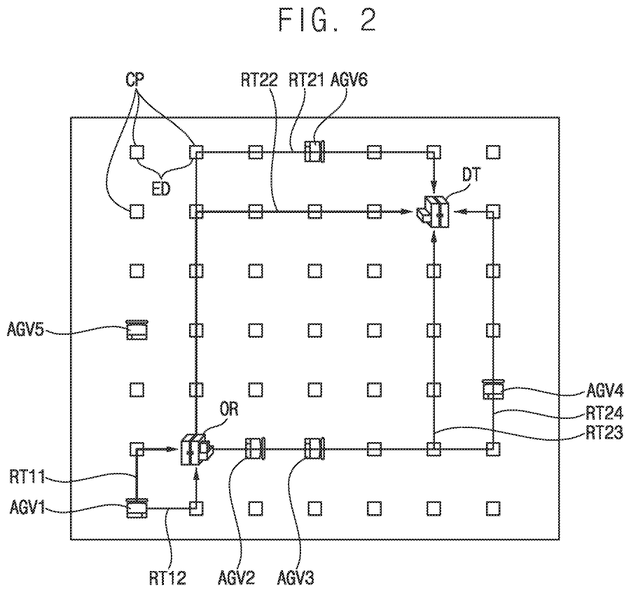

FIG. 1 is a route determining system of an automated guided vehicle according to an embodiment of the present invention. FIG. 2 is a conceptual diagram illustrating the route determining system of the automated guided vehicle of FIG. 1.

Referring to FIGS. 1 and 2, the route determining system of the automated guided vehicle may include a plurality of automated guided vehicles AGV1, AGV2, AGV3, AGV4, AGV5 and AGV6 and a controller 100 for communicating with the automated guided vehicles AGV1, AGV2, AGV3, AGV4, AGV5 and AGV6.

Although the route determining system includes six automated guided vehicles AGV1, AGV2, AGV3, AGV4, AGV5 and AGV6 in FIGS. 1 and 2, the present invention may not be limited to the total number of the automated guided vehicles in the route determining system. The route determining system may include more than six automated guided vehicles in another embodiment. Alternatively, the route determining system may include less than six automated guided vehicles.

The controller 100 may determine whether a work is assigned to a main automated guided vehicle or not. Herein, the main automated guided vehicle may mean an automated guided vehicle for performing the work. The controller 100 may predict a route of the main automated guided vehicle considering an operation of other automated guided vehicles except for the main automated guided vehicle.

When the work is assigned to the main automated guided vehicle, the controller 100 may extract a first control point and a second control point of the work. The controller 100 may determine whether the total number of routes from the first control point to the second control point is multiple or not. When the total number of the routes from the first control point to the second control point is one, the single route may be determined as a final route of the main automated guided vehicle. When the total number of the routes from the first control point to the second control point is equal to or greater than two, the controller 100 may predict the moving time of the main automated guided vehicle for all candidate routes and determine the shortest time route among the candidate routes as the final route of the main automated guided vehicle.

The controller 100 may determine current positions of the automated guided vehicles AGV1, AGV2, AGV3, AGV4, AGV5 and AGV6. In addition, the controller 100 may determine simulation times for the automated guided vehicles AGV1, AGV2, AGV3, AGV4, AGV5 and AGV6 to work.

In an operation of determining the final route of the main automated guided vehicle, the controller 100 may check automated guided vehicles positioned ahead on the route for each of the plurality of automated guided vehicles AGV1, AGV2, AGV3, AGV4, AGV5 and AGV6.

In addition, in the operation of determining the final route of the main automated guided vehicle, the controller 100 may check a crossing automated guided vehicle crossing the same intersection with the main automated guided vehicle.

In a conventional method, the route is determined based on a moving distance. Thus, in the conventional method, a system situation according to congestion of other automated guided vehicles is not reflected to the route so that the working time may be difficult to predict. In addition, when the working time is predicted based only on past information, the moving influence of other automated guided vehicles cannot be reflected to the route of the automated guided vehicle which is moving.

The controller 100 may accurately predict the moving time of the main automated guided vehicle and determine an optimal route of the main automated guided vehicle based on future information regarding the simulation times of other automated guided vehicles and working positions of other automated guided vehicles.

In FIG. 2, the route determining system of the automated guided vehicle includes six automated guided vehicles AGV1, AGV2, AGV3, AGV4, AGV5 and AGV6, and the automated guided vehicles AGV1, AGV2, AGV3, AGV4, AGV5 and AGV6 may move based on control points CP. Herein, the automated guided vehicles AGV1, AGV2, AGV3, AGV4, AGV5 and AGV6 may move toward an adjacent control point CP in a horizontal direction and in a vertical direction.

In FIG. 2, a path between the adjacent control points CP may be referred to as an edge ED, an origin (i.e., starting point) of a transport work is represented as OR and a destination of the transport work is represented as DT.

The work may include a first work in which the main automated guided vehicle moves to the origin OR and a second work in which the main automated guided vehicle moves from the origin OR to the destination DT. The first work in which the main automated guided vehicle moves to the origin OR (i.e., starting point) to load an object may be referred to as a retrieve job, and the second work in which the main automated guided vehicle transports the object from the origin OR to the destination DT may be referred to as a delivery job. The work may refer to both the first work in which the main automated guided vehicle moves to the origin OR (i.e., starting point) and the second work in which the main automated guided vehicle load the object and transports the object from the origin OR to the destination DT.

In FIG. 2, there may be two routes, including a first route RT11 and a second route RT12, along which the first automated guided vehicle AGV1 moves to the origin OR. The controller 100 may determine the shortest time route among the first route RT11 and the second route RT12 as an optimal route along which the first automated guided vehicle AGV1 moves to the origin OR.

In FIG. 2, there may be four routes, including a third route RT21, a fourth route RT22, a fifth route RT23 and a sixth route RT24, along which the first automated guided vehicle AGV1 moves from the origin OR to the destination DT. The controller 100 may determine the shortest time route among the third route RT21, the fourth route RT22, the fifth route RT23 and the sixth route RT24 as an optimal route along which the first automated guided vehicle AGV1 moves from the origin OR to the destination DT.

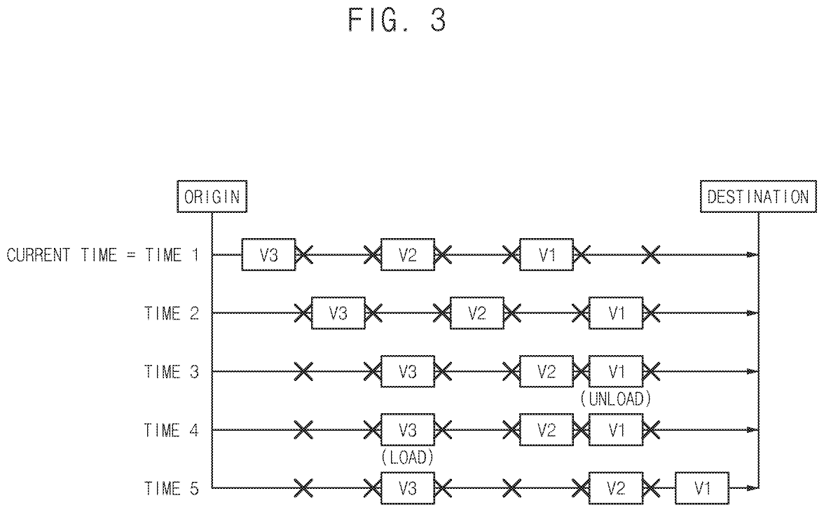

FIG. 3 is a conceptual diagram illustrating movements of the automated guided vehicles over time in the route determining system of the automated guided vehicle of FIG. 1.

Referring to FIGS. 1 to 3, the controller 100 may determine a predicted moving time. The controller 100 may divide a time frame in a unit of a predetermined time. If there is an automated guided vehicle positioned ahead on the route, the automated guided vehicle may not overtake the automated guided vehicle positioned ahead. In addition, when a plurality of automated guided vehicles passes through the same intersection, priorities among the automated guided vehicles may be determined.

In a first time TIME1 of FIG. 3, an automated guided vehicle V1, an automated guided vehicle V2 and an automated guided vehicle V3 may be sequentially positioned between the destination and the origin (i.e., starting point). Herein, the automated guided vehicle V2 may be a main automated guided vehicle which performs a work for transporting an object from the origin (i.e., starting point) to the destination.

In a second time TIME2 of FIG. 3, the automated guided vehicle V1, the automated guided vehicle V2 and the automated guided vehicle V3 may each move toward the destination by one control point.

In a third time TIME3 of FIG. 3, the automated guided vehicle V1 may stop and unload an object. In the third time TIME3 of FIG. 3, the automated guided vehicle V2 and the automated guided vehicle V3 may each further move toward the destination by one control point.

In a fourth time TIME4 of FIG. 3, the automated guided vehicle V1 may stop after unloading the object. In the fourth time TIME4 of FIG. 3, the automated guided vehicle V2 may not move further due to the automated guided vehicle V1 and may stay at a position in the third time TIME3. In the fourth time TIME4 of FIG. 3, the automated guided vehicle V3 may stop to load an object.

In a fifth time TIME5 of FIG. 3, the automated guided vehicle V1 and the automated guided vehicle V2 may each move toward the destination by one control point. In the fifth time TIME5 of FIG. 3, the automated guided vehicle V3 may stop after loading the object.

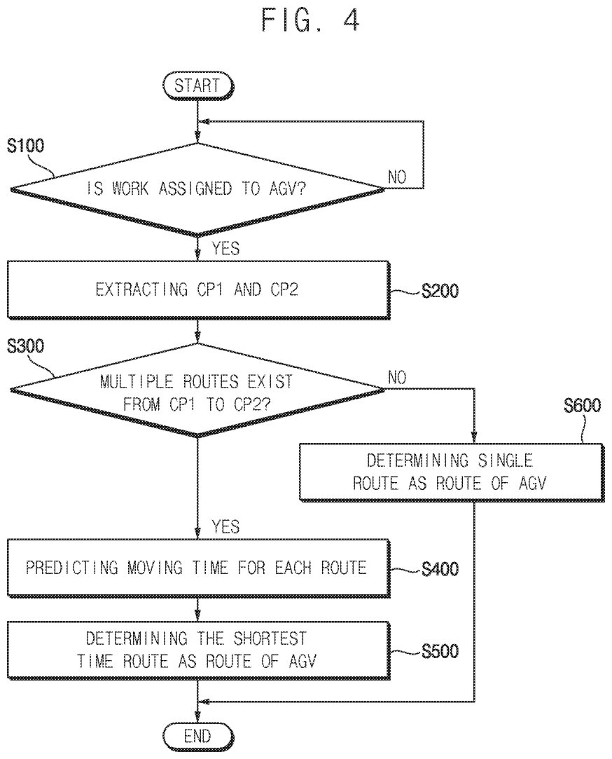

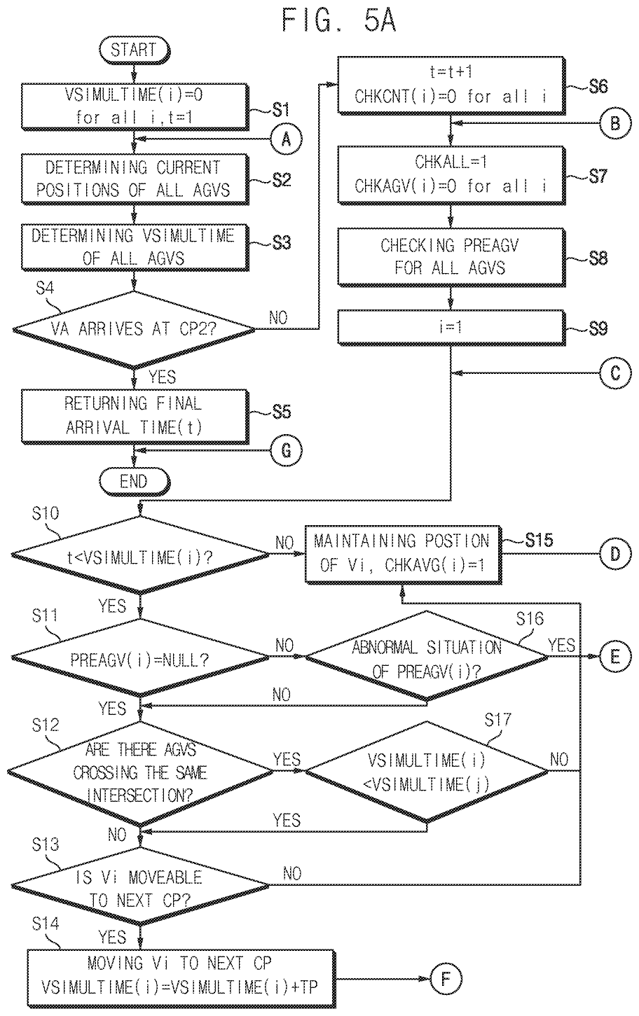

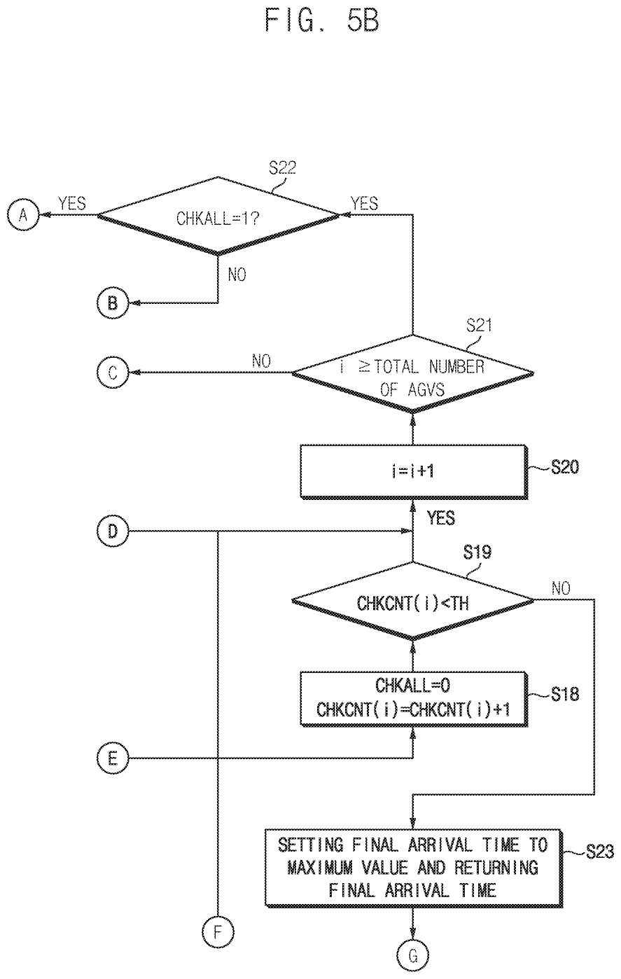

FIG. 4 is a flowchart diagram illustrating a method of determining the route of the automated guided vehicle performed by the route determining system of the automated guided vehicle of FIG. 1. FIGS. 5A and 5B are flowchart diagrams illustrating a step of predicting a moving time for each route in the method of determining the route of the automated guided vehicle of FIG. 4.

Referring to FIGS. 1 to 5B, the method of determining the route of the automated guided vehicle (“AGV”) may include: determining whether the work is assigned to the main automated guided vehicle VA (operation S100); extracting the first control point CP1 and the second control point CP2 of the work when the work is assigned to the main automated guided vehicle VA (operation S200); determining whether multiple routes exist from the first control point CP1 to the second control point CP2 (operation S300); determining a single route as the final route of the main automated guided vehicle VA when the total number of the routes from the first control point CP1 to the second control point CP2 is one (operation S600); predicting the moving time of the main automated guided vehicle VA for all candidate routes when the total number of the routes from the first control point CP1 to the second control point CP2 is equal to or greater than two (operation S400); and determining the shortest time route among the candidate routes as the final route of the main automated guided vehicle VA (operation S500).

When the work is not assigned to the main automated guided vehicle VA in the operation of determining whether the work is assigned to the main automated guided vehicle VA (operation S100), the operation S100 may be repeated until the work is assigned to the main automated guided vehicle VA.

In the operation of predicting the moving time of the main automated guided vehicle VA (operation S400), the current positions of the automated guided vehicles (AGV) in an unmanned transport system and simulation times for the automated guided vehicles in the unmanned transport system may be determined.

In the operation of predicting the moving time of the main automated guided vehicle VA (operation S400), the automated guided vehicles positioned ahead on the route for each of the plurality of automated guided vehicles in the unmanned transport system may be checked.

In the operation of predicting the moving time of the main automated guided vehicle VA (operation S400), the crossing automated guided vehicle crossing the same intersection with the main automated guided vehicle VA may be checked. Herein, the vehicle having a long simulation time may obtain a priority among the main automated guided vehicle VA and the crossing automated guided vehicle.

For example, the first control point CP1 may be a control point right after the origin OR, and the second control point CP2 may be a control point right before the destination DT. Alternatively, the second control point CP2 may be a control point of the destination DT. When the automated guided vehicle (AGV) is disposed between the origin OR and the control point right after the origin, a moving route of the automated guided vehicle may be determined based on the control point right after the origin OR. Herein, the origin OR (i.e., starting point) may be the current position of the automated guided vehicle.

The operation of predicting the moving time of the main automated guided vehicle VA (operation S400) may include: initializing the simulation times VSIMULTIME of all of the automated guided vehicles (AGV) in the unmanned transport system and a current time t (operation S1), determining the current positions of all of the automated guided vehicles (operation S2) and determining the simulation times VSIMULTIME of all of the automated guided vehicles (AGV) (operation S3).

The operation of predicting the moving time of the main automated guided vehicle VA (operation S400) may further include: determining whether the main automated guided vehicle VA arrives at the second control point CP2 (operation S4) and returning the current time t as a final arrival time when the main automated guided vehicle VA arrives at the second control point CP2 (operation S5).

The operation of predicting the moving time of the main automated guided vehicle VA (operation S400) may further include: increasing the current time t by 1 (i.e., one unit time) and initializing a check count CHKCNT of all of the automated guided vehicles (AGV) when the main automated guided vehicle VA does not arrive at the second control point CP2 (operation S6), initializing an error signal CHKALL of the candidate route and initializing status signals CHKAGV of all of the automated guided vehicles (operation S7), checking the automated guided vehicles (“PREAGV”) positioned ahead on the route for each of the plurality of automated guided vehicles (AGV) in the unmanned transport system (operation S8) and initializing a sequence i of the automated guided vehicle in the unmanned transport system to 1 (operation S9).

Herein, the error signal CHKALL of the candidate route may indicate that it is not appropriate to select the candidate route. When the error signal CHKALL of the candidate route is 1, it may represent an initial status (a normal status) having no error. When the error signal CHKALL of the candidate route is 0, it may represent an error status indicating that an error is suspected.

In the operation S7, the error signal CHKALL of the candidate route may be initialized to 1. In the present embodiment, when the error status in which the error signal CHKALL of the candidate route is 0 is repeated several times (e.g., when check count CHKCNT is greater than or equal to threshold TH) (operation S19), the final arrival time of the candidate route may be set to a maximum value and the final arrival time having the maximum value may be returned (operation S23). Returning the final arrival time of the candidate route as the maximum value (operation S23) indicates that the candidate route should not be selected as an optimal route.

Herein, the status signal CHKAGV of the automated guided vehicle may indicate that a problem of the automated guided vehicle (AGV) is suspected. When the status signal CHKAGV of the automated guided vehicle is 1, it may represent a normal status with no suspected problem. When the status signal CHKAGV of the automated guided vehicle is 0, it may represent an abnormal status with the suspected problem. The status signal CHKAGV of the automated guided vehicle may be initialized to 0, and may be changed to 1 when there is no problem after checking the status of the automated guided vehicle.

The operation of predicting the moving time of the main automated guided vehicle VA (operation S400) may further include: determining whether a simulation time VSIMULTIME(i) of an i-th automated guided vehicle is greater than the current time t (operation S10), determining the status signal CHKAGV of the i-th automated guided vehicle as the normal status when the simulation time VSIMULTIME(i) of the i-th automated guided vehicle is less than or equal to the current time t (operation S15) and increasing the sequence i of the automated guided vehicle by 1 (operation S20). Increasing the sequence i by 1 may mean a current step is moved to a step of checking the status of a next automated guided vehicle.

The operation of predicting the moving time of the main automated guided vehicle VA (operation S400) may further include: determining whether the sequence i is greater than or equal to the total number of the automated guided vehicles in the unmanned transport system after increasing the sequence i by 1 (operation S21) and checking the error signal CHKALL of the candidate route (operation S22) when the sequence i is greater than or equal to the total number of the automated guided vehicles in the unmanned transport system after increasing the sequence i by 1. If the sequence i is greater than or equal to the total number of the automated guided vehicles in the unmanned transport system, it may mean that the status check for all of the automated guided vehicles in the unmanned transport system is completed.

When the error signal CHKALL of the candidate route has the error status, the flow may move to the operation S7 in which the error signal CHKALL of the candidate route is initialized and the status signals CHKAGV of all of the automated guided vehicles (AGV) are initialized. When the error signal CHKALL of the candidate route has the error status, the error signal CHKALL of the candidate route and the status signals CHKAGV of all of the automated guided vehicles are initialized and the process of checking the error signal CHKALL of the candidate route may be repeated.

In contrast, when the error signal CHKALL of the candidate route has the normal status, the flow may move to the operation S2 in which the current positions of all of the automated guided vehicles are determined. When the error signal CHKALL of the candidate route has the normal status, the process of checking the error signal CHKALL of the candidate route may not be repeated but the operations S2, S3 and S4 may be performed to check whether the main automated guided vehicle VA arrives at the second control point CP2.

When the sequence i is less than the number of the automated guided vehicles (AGV) in the unmanned transport system, the flow may move to the operation S10 in which whether the simulation time VSIMULTIME(i) of the i-th automated guided vehicle is greater than the current time t is determined. When the sequence i is less than the number of the automated guided vehicles in the unmanned transport system, it means that the status check for all automated guided vehicles in the unmanned transport system is not completed.

The operation of predicting the moving time of the main automated guided vehicle VA (operation S400) may further include: determining whether the automated guided vehicle (PREAGV) positioned ahead does not exist on the route for the i-th automated guided vehicle (operation S11) when the simulation time of an i-th automated guided vehicle is greater than the current time in the operation S10, determining whether the automated guided vehicle positioned ahead is in an abnormal situation (operation S16) when the automated guided vehicle positioned ahead exists on the route for the i-th automated guided vehicle, updating the error signal CHKALL of the candidate route to the error status and increasing the check count CHKCNT of the i-th automated guided vehicle by 1 (operation S18) when the automated guided vehicle positioned ahead is in the abnormal situation, determining whether the check count CHKCNT of the i-th automated guided vehicle is less than a threshold TH (operation S19) and returning the final arrival time of the candidate route as the maximum value (operation S23) when the check count CHKCNT of the i-th automated guided vehicle is greater than or equal to the threshold TH.

For example, in the operation S16 of determining whether the automated guided vehicle positioned ahead is in the abnormal situation, it may be determined that the automated guided vehicle positioned ahead is in the abnormal situation when the position of the automated guided vehicle positioned ahead is not determined.

When the simulation time VSIMULTIME(i) of the i-th automated guided vehicle is greater than the current time t, it may mean the abnormal status of the i-th automated guided vehicle with the suspected problem. In contrast, when the simulation time VSIMULTIME(i) of the i-th automated guided vehicle is less than the current time t, it may mean that the normal status of the i-th automated guided vehicle.

When the check count CHKCNT of the i-th automated guided vehicle is less than the threshold TH, the operation S20 of increasing the sequence i by 1 may be performed.

The operation of predicting the moving time of the main automated guided vehicle VA (operation S400) may further include determining whether the crossing automated guided vehicle crossing the same intersection with the i-th automated guided vehicle exists (operation S12) when the automated guided vehicle positioned ahead is not in the abnormal situation in the operation S16 and comparing the simulation time VSIMULTIME(i) of the i-th automated guided vehicle and a simulation time VSIMULTIME(j) of the crossing automated guided vehicle (operation S17) when the crossing automated guided vehicle exists.

When the simulation time VSIMULTIME(i) of the i-th automated guided vehicle is greater than or equal to the simulation time VSIMULTIME(j) of the crossing automated guided vehicle, the operation S15 in which the status signal CHKAGV of the i-th automated guided vehicle is determined as the normal status may be performed.

The operation of predicting the moving time of the main automated guided vehicle VA (operation S400) may further include determining whether the i-th automated guided vehicle is movable to the next control point (operation S13) when the crossing automated guided vehicle does not exist in the operation S12 or when the simulation time VSIMULTIME(i) of the i-th automated guided vehicle is less than the simulation time VSIMULTIME(j) of the crossing automated guided vehicle in the operation S17 and moving the i-th automated guided vehicle to the next control point when the i-th automated guided vehicle is movable to the next control point and adding a rotation time to the simulation time of the i-th automated guided vehicle when a rotation of the i-th automated guided vehicle is required (operation S14).

When the i-th automated guided vehicle is not movable to the next control point, the operation S15 of determining the status signal CHKAGV of the i-th automated guided vehicle as the normal status may be performed.

According to the embodiments, the shortest route may be determined as the route of the automated guided vehicle through the real-time simulation of the moving time of the automated guided vehicles so that the moving time of the automated guided vehicle (AGV) may be reduced.

The influence of the movement of other automated guided vehicles is reflected to the moving route of the automated guided vehicle and traffic and congestion are reflected to the moving route of the automated guided vehicle so that the moving route of the automated guided vehicle may be optimized.

According to the method of determining the route of the automated guided vehicle and the route determining system of the automated guided vehicle of the present embodiment as explained above, the shortest route may be determined as the route of the automated guided vehicle through the real-time simulation of the moving time of the automated guided vehicles so that the moving route of the automated guided vehicle may be optimized.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of determining a route of a main automated guided vehicle, the method comprising:
determining whether a work is assigned to the main automated guided vehicle;
extracting a first control point and a second control point of the work when the work is assigned to the main automated guided vehicle;
determining whether multiple routes exist from the first control point to the second control point;
determining a single route as a final route of the main automated guided vehicle when a total number of routes from the first control point to the second control point is one;
predicting a moving time of the main automated guided vehicle for all candidate routes and determining a shortest time route among the candidate routes as the final route of the main automated guided vehicle, when the total number of the routes from the first control point to the second control point is equal to or greater than two.

2. The method of claim 1, wherein the predicting of the moving time of the main automated guided vehicle comprises determining current positions of automated guided vehicles in an unmanned transport system including the main automated guided vehicle and simulation times for the automated guided vehicles in the unmanned transport system.

3. The method of claim 1, wherein the predicting of the moving time of the main automated guided vehicle comprises checking automated guided vehicles positioned ahead on a route for each of automated guided vehicles in an unmanned transport system including the main automated guided vehicle.

4. The method of claim 1, wherein the predicting of the moving time of the main automated guided vehicle comprises checking a crossing automated guided vehicle crossing a same intersection with the main automated guided vehicle.

5. The method of claim 4, wherein a vehicle having a long simulation time of the main automated guided vehicle and the crossing automated guided vehicle obtains a priority.

6. The method of claim 1, wherein the first control point is a control point right after a starting point; and
wherein the second control point is a control point right before a destination.

7. The method of claim 1, wherein the first control point is a control point right after a starting point; and
wherein the second control point is a control point of a destination.

8. The method of claim 1, wherein the predicting of the moving time of the main automated guided vehicle comprises:
initializing simulation times of all of automated guided vehicles in an unmanned transport system including the main automated guided vehicle and a current time (operation S1);
determining current positions of all of the automated guided vehicles (operation S2); and
determining the simulation times of all of the automated guided vehicles (operation S3).

9. The method of claim 8, wherein the predicting of the moving time of the main automated guided vehicle further comprises:
determining whether the main automated guided vehicle arrives at the second control point (operation S4); and
returning the current time as a final arrival time when the main automated guided vehicle arrives at the second control point (operation S5).

10. The method of claim 8, wherein the predicting of the moving time of the main automated guided vehicle further comprises:
determining whether the main automated guided vehicle arrives at the second control point (operation S4);
increasing the current time by one unit time and initializing a check count (CHKCNT) of all of the automated guided vehicles when the main automated guided vehicle does not arrive at the second control point CP2 (operation S6);
initializing an error signal (CHKALL) of the candidate routes and initializing status signals (CHKAGV) of all of the automated guided vehicles (operation S7);
checking automated guided vehicles positioned ahead on the candidate routes for each of the automated guided vehicles in the unmanned transport system (operation S8); and
initializing a sequence (i) of a tested automated guided vehicle among the automated guided vehicles in the unmanned transport system to 1 (operation S9).

11. The method of claim 10, wherein the predicting of the moving time of the main automated guided vehicle further comprises:
determining whether the simulation time of an i-th automated guided vehicle is greater than the current time (operation S10); and
determining the status signal (CHKAGV) of the i-th automated guided vehicle as a normal status when the simulation time of the i-th automated guided vehicle is less than or equal to the current time (operation S15) and increasing the sequence (i) of the tested automated guided vehicle by 1 (operation S20).

12. The method of claim 11, wherein the predicting of the moving time of the main automated guided vehicle further comprises:
determining whether the sequence (i) is greater than or equal to a total number of the automated guided vehicles in the unmanned transport system after increasing the sequence (i) by 1 (operation S21); and
checking the error signal (CHKALL) of the candidate routes when the sequence (i) is greater than or equal to the total number of the automated guided vehicles in the unmanned transport system after increasing the sequence (i) by 1 (operation S22),
wherein when the error signal (CHKALL) of the candidate route has a normal status, the operation S2 in which the current positions of all of the automated guided vehicles are determined is performed, and
wherein when the sequence (i) is less than the total number of the automated guided vehicles in the unmanned transport system, the operation S10 in which whether the simulation time of the i-th automated guided vehicle is greater than the current time is determined is performed.

13. The method of claim 12, wherein the predicting of the moving time of the main automated guided vehicle further comprises:
determining whether the automated guided vehicle positioned ahead does not exist on the routes for the i-th automated guided vehicle (operation S11) when the simulation time of an i-th automated guided vehicle is greater than the current time in the operation S10;
determining whether the automated guided vehicle positioned ahead of the i-th automated guided vehicle is in an abnormal situation (operation S16) when the automated guided vehicle positioned ahead exists on the route for the i-th automated guided vehicle;
updating the error signal (CHKALL) of the candidate routes to the error status and increasing the check count (CHKCNT) of the i-th automated guided vehicle by 1 (operation S18) when the automated guided vehicle positioned ahead is in the abnormal situation;
determining whether the check count (CHKCNT) of the i-th automated guided vehicle is less than a threshold (operation S19); and
returning the final arrival time of the candidate routes as a maximum value (operation S23) when the check count (CHKCNT) of the i-th automated guided vehicle is greater than or equal to the threshold, and
wherein when the check count (CHKCNT) of the i-th automated guided vehicle is less than the threshold, the operation S20 of increasing the sequence (i) by 1 is performed.

14. The method of claim 13, wherein the predicting of the moving time of the main automated guided vehicle further comprises:
determining whether a crossing automated guided vehicle crossing a same intersection with the i-th automated guided vehicle exists (operation S12) when the automated guided vehicle positioned ahead is not in the abnormal situation in the operation S16; and
comparing the simulation time of the i-th automated guided vehicle and a simulation time of the crossing automated guided vehicle (operation S17) when the crossing automated guided vehicle exists, and
wherein when the simulation time of the i-th automated guided vehicle is greater than or equal to the simulation time of the crossing automated guided vehicle, the operation S15 in which the status signal (CHKAGV) of the i-th automated guided vehicle is determined as the normal status is performed.

15. The method of claim 14, wherein the predicting of the moving time of the main automated guided vehicle further comprises:
determining whether the i-th automated guided vehicle is movable to a next control point (operation S13) when the crossing automated guided vehicle does not exist in the operation S12 or when the simulation time of the i-th automated guided vehicle is less than the simulation time of the crossing automated guided vehicle in the operation S17; and
moving the i-th automated guided vehicle to the next control point when the i-th automated guided vehicle is movable to the next control point, and adding a rotation time to the simulation time of the i-th automated guided vehicle when a rotation of the i-th automated guided vehicle is required (operation S14), and
wherein when the i-th automated guided vehicle is not movable to the next control point, the operation S15 of determining the status signal (CHKAGV) of the i-th automated guided vehicle as the normal status is performed.

16. The method of claim 1, wherein the work includes a first work in which the main automated guided vehicle moves to a starting point and a second work in which the main automated guided vehicle moves from the starting point to a destination.

17. A route determining system of a main automated guided vehicle, the route determining system comprising:
a plurality of automated guided vehicles including the main automated guided vehicle; and
a controller configured to communicate with the automated guided vehicles, and
wherein the controller is configured to:
determine whether a work is assigned to the main automated guided vehicle;
extract a first control point and a second control point of the work when the work is assigned to the main automated guided vehicle;
determine whether multiple routes exist from the first control point to the second control point;
determine a single route as a final route of the main automated guided vehicle when a total number of routes from the first control point to the second control point is one;
predict a moving time of the main automated guided vehicle for all candidate routes and determine a shortest time route among the candidate routes as the final route of the main automated guided vehicle, when the total number of the routes from the first control point to the second control point is equal to or greater than two.

18. The route determining system of claim 17,
wherein the controller is configured to determine current positions of the automated guided vehicles and simulation times for the automated guided vehicles.

19. The route determining system of claim 17,
wherein the controller is configured to check automated guided vehicles positioned ahead on the routes for each of the plurality of automated guided vehicles.

20. The route determining system of claim 17,
wherein the controller is configured to check a crossing automated guided vehicle crossing a same intersection with the main automated guided vehicle.
